(19) United States
(12) Patent Application Publication
(10) Pub. No.: US 2006/0158022 A1
(43) Pub. Date: Jul. 20, 2006

(54) Rear wheel and rear wheel hub for bicycles

(76) Inventor: Karlheinz Nicolai, Lubbrechtsen (DE)

Correspondence Address: GREENBLUM & BERNSTEIN, P.L.C., 1950 ROLAND CLARKE PLACE, RESTON, VA, 20191, US

(21) Appl. No.: 11/305,354

(22) Filed: Dec. 19, 2005

(30) Foreign Application Priority Data
Dec. 26, 2004 (DE) 10 2004 063 505.6

(51) Int. Cl. B60B 27/00

(52) U.S. Cl. 301/110.5

(57) ABSTRACT

A rear wheel and a rear wheel hub for bicycles, the rear wheel being mounted between two components of the bicycle frame, which are generally referred to as dropouts, and is mounted removably, and the rear wheel hub of the rear wheel being configured indirectly or directly to accommodate brake components and drive elements, comprising the following features: a) at least one coupling component is arranged on at least one dropout, b) a hub body is arranged on at least one coupling component in a manner such that it can be separated on the coupling side, c) a brake component is arranged permanently and indirectly or directly on at least one coupling component, d) a drive element is arranged permanently and indirectly or directly on at least one coupling component, e) there is a releasable connection to a single-or multi-part connecting component at least within one dropout, at least within one coupling component and within the hub body, f) on at least one coupling component there is a ball, roller or needle bearing in relation to the dropout or in relation to the connecting component.

The invention relates to a rear wheel or a rear wheel hub for bicycles and to a constructional unit for use in the bicycle.

Bicycles often have removable rear wheels which make it possible for the user to better transport the bicycle. In the case of sporting use of the bicycle, it is also expedient to have different rear wheels with different tyre profiles available.

When bicycles are equipped with what is referred to as a dérailleur gearshift, on the rear wheel hub there are a plurality of sprockets with different numbers of teeth that are connected to the rear wheel hub body via a freewheel. The gear-shifting operation is carried out by a dérailleur which drops the chain from one sprocket to the adjacent sprocket.

This dérailleur gearshift arrangement is open and is lubricated by oil or grease.

If, in the case of these bicycles with a dérailleur gearshift, the rear wheel is to be removed or fitted, the operator inevitably comes into contact with the oiled components and soiling of the surfaces of the hands generally cannot be prevented. Similarly, use is often made on bicycles of what are referred to as hub gearshifts which have a planetary gear mechanism within their hub body and are driven just by a single sprocket via a chain. Nevertheless, even in the case of these bicycles, the user comes into contact with the chain when taking off the rear wheel and when installing the rear wheel, since the rear wheel together with the sprocket has to be manually introduced into the chain. Furthermore, novel developments described as bicycles with a gear mechanism in the main frame are known from DE 10339207.6 and also PCT Patent number DE 00/02968.

However, here too a chain runs from the area of the pedal cranks to the rear wheel onto a sprocket. These novel bicycles are therefore also affected by the disadvantage that a soiling of the operator cannot be ruled out during removal and fitting of the rear wheel. The awkward handling of the chain when installing and taking off the rear wheel can often only be learnt with difficulty by the lay person and is therefore also to be considered a disadvantage. Also, in modern times disk brakes are often fitted to rear wheels of bicycles. The brake caliper is usually fitted to the bicycle frame or to the rear structure of the bicycle frame. By contrast, the brake disk is screwed fixedly to the rear wheel hub and, during the fitting of the rear wheel, has to be awkwardly introduced between the brake linings. This handling is also considered disadvantageous in the prior art. What makes it worse is that, in the case of bicycles with disk brakes, frequently the brake lever must not be pulled when the rear wheel has been taken off because it makes it impossible to subsequently install the brake disk. To install the rear wheel, the brake linings have to be pressed apart by a screwdriver or another suitable tool. Since, however, the user cannot rule out that the brake lever of the bicycle will be unintentionally pulled during transportation, existing constructions with disk brakes are also disadvantageous in respect of product reliability.

Starting from this problem, the intention is to improve the bicycles described at the beginning.

To solve the problem, the rear wheel (1) of the generic type and the rear wheel hub of the generic type for bicycles is distinguished by the following features:
a) at least one coupling component (11, 12) is arranged on at least one of two components of a bicycle frame that will be referred to in general as dropouts (8),
b) a hub body (10) is arranged on at least one coupling component (11, 12) in a manner such that it can be separated on the coupling side,
c) a brake component (14) is arranged permanently and indirectly or directly on at least one coupling component (11, 12),
d) a drive element (13) is arranged permanently and indirectly or directly on at least one coupling component (11, 12),
e) there is a releasable connection to a connecting component (18), at least within one dropout (8), at least within one coupling component (11, 12) and within the hub body (10),
f) on at least one coupling component (11, 12) there is a rotary bearing (16) in relation to the dropout (8) or in relation to the connecting component (18).

Owing to the fact that the rear wheel hub comprises at least one coupling component (11, 12) on which the brake components (14) or else drive elements (13) are arranged directly or via intermediate components, it is possible to remove the rear wheel (1) by releasing and removing a connecting component (18). This is achieved by the separability of the hub body (10) from the coupling components (11, 12) on the coupling side. Since the coupling component or the coupling components (11, 12) are mounted on the dropout (8), they remain on the rear structure (3) of the bicycle frame (2) during the removal of the rear wheel. Since the brake components (14) or else drive elements (13) therefore also always remain in the operationally ready state on the bicycle frame (2), the novelty constitutes an improvement over the prior art. By way of example, the remaining of the chain (4) on the pinion (9) and the remaining of the brake disk (7) in the brake calliper are regarded as an operationally ready state. A soiling with oil is ruled out. Likewise, all of the brake components remain completely fitted and greater operational reliability is achieved for this reason.

It is advantageous to mount the coupling component (11, 12) with a ball, roller or needle bearing (16) in relation to the dropout (8) or in relation to the connecting component (18) since small frictional losses are thereby achieved.

The connecting component (18) may also be designed as a multi-part connecting component (19) in order to achieve advantages with regard to the manufacturing and operability.

Easy releasability of connecting component (18) from coupling component (11, 12) is achieved by means of a thread (27). Production costs are also reduced by this type of embodiment.

Axial displaceability of connecting component (18) in relation to coupling component (11, 12) is preferably achieved by means of a hole (27). Here too, production costs are reduced by this type of embodiment.

The transmission of the braking and driving torques between the coupling components (11, 12) and the hub body (10) during riding of the bicycle preferably takes place via elevations and grooves (17) on the end sides of the coupling components (11, 12) and of the hub body (10).

If the brake components (14) and the drive elements (13) are not arranged on the same coupling component, then the drive elements (13) cannot let any negative disturbances pass to the brake components (14). An example which could be mentioned in this case is the disk brake linings becoming fouled by oil due to chain lubricant being thrown about.

If, after the connection of the connecting component (18) is released, the hub body is arranged in an axially moveable manner relative to at least one coupling component (11, 12), then this axial movement brings about a decoupling of the end-side elevations and grooves (17) and the rear wheel (1) can very easily be removed by a short axial movement with subsequent pulling of the rear wheel (1) out of the rear structure (3).

In an advantageous manner, after the connecting components (18) are released, one coupling component (11, 12) can be displaced axially within and relative to a dropout (8) because the taking off of the rear wheel is thereby additionally simplified.

Analogously to this, the axial movability of a coupling component (11, 12) relative to a dropout (8) can advantageously be stopped by a clamping or another type of axial fixing, since the rigidity of the rear structure (3) is thereby increased. This has a positive effect on the riding safety and riding characteristic.

A further additional function can be integrated in the arrangement if the bearing (16) is constructed in a manner such that it can be displaced relative to the dropout (8) and therefore to the bicycle frame (2). If, for example, a chain (4) and a chain pinion (9) is used as drive element (13), then the chain tensioning can take place via this construction.

High torques from the drive or from braking can be transmitted between hub body (10) and coupling components (11, 12) when the elevations and grooves (17) on the end sides of the coupling components (11, 12) and of the hub body (10) have a polygonal form (28) or involute form. This likewise simplifies the production capability, since these forms are a common standard in the industry.

The elevations and grooves (17) on the end sides of the coupling components (11, 12) and of the hub body (10) are preferably of wedge-shaped design, since freedom from play can more easily be achieved in this manner.

In many spheres of use, it is advantageous to introduce the reaction moment produced by the braking operation on the rear wheel (1) into different components as desired, since, in a correct configuration, the braking operation in this manner does not have any effect on the cushioning comfort. To this end, on one coupling component (11, 12) there should be a ball, roller or needle bearing (24) for the indirect receptacle (22) of a brake calliper. This receptacle is often called an anti-dive support (26).

This anti-dive support (26) or the coupling component only (11, 12), should advantageously remain permanently connected to the dropout (8), since the brake components (14) or else drive elements (13) therefore also always remain in the operationally ready state on the bicycle frame (2) and a securing of the coupling component (11, 12) during the taking off of the wheel is not necessary.

In order to be able to use the arrangement in different types of bicycle, it is advantageous if the hub body (10) is connected to the rim (6) of the rear wheel (1) via steel spokes (5) or composite fiber materials.

A more rapid taking off of the wheel is achieved if the releasable connection between coupling components (11, 12) and connecting component (18) is released with the aid of an eccentric clamp or a disk cam.

In order to keep the weight of the rear wheel (1) and of the rear wheel hub as low as possible and nevertheless to be able to transmit high torques from the drive or from braking between hub body (10) and coupling components (11, 12), the elevations and grooves on the end surfaces (17) of the coupling components (11, 12) and on the hub body (10) should be composed of a different material from the hub body (10) and the coupling components (11, 12) themselves. The different material can be achieved, for example, by a coating or by a multi-part construction.

A particularly simple and cost-effectively producible separability between coupling components (11, 12) and hub body (10) is achieved via a thread on the end surfaces (17).

For use of the bicycle off road with severe soiling, the drive element (13) of the rear wheel (1) should be configured as a chain sprocket (9), since the dirt can escape through the openings in the roller chain (4).

For use of the bicycle on the road, the drive element (13) of the rear wheel (1) should be configured as a synchronous belt drive, since quiet running and a low degree of wear increase the user's comfort.

It is advantageous if the brake component (14) of the rear wheel (1) is designed as a disk brake since rim brakes lead to deformation and wear of the rim body. The dissipation of heat is also better than in the case of drum brakes.

An equal load on the spokes and introduction of force into the rear structure increase the stability of the bicycle frame. For this reason, a symmetrical arrangement of the hub body (10) and of the coupling components (11, 12) between the dropouts (8) is advantageous.

Exemplary embodiments of the invention will be explained in more detail below with the aid of a drawing, in which:

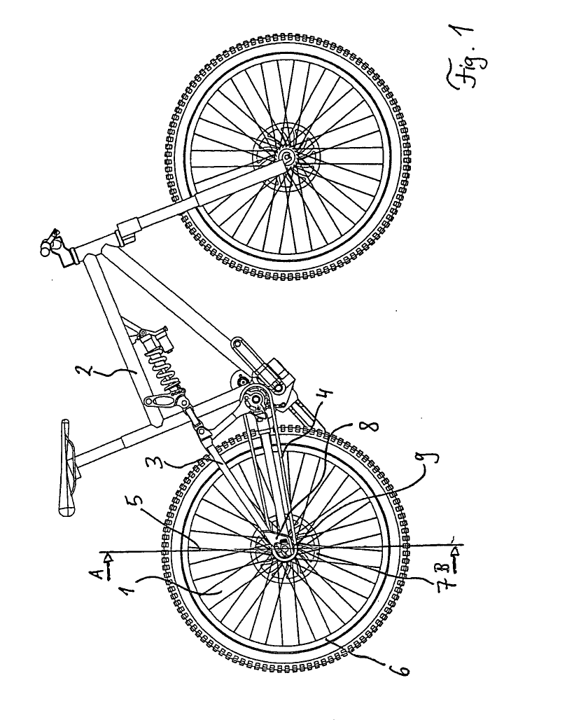

FIG. 1 shows an entire bicycle with the rear wheel installed;

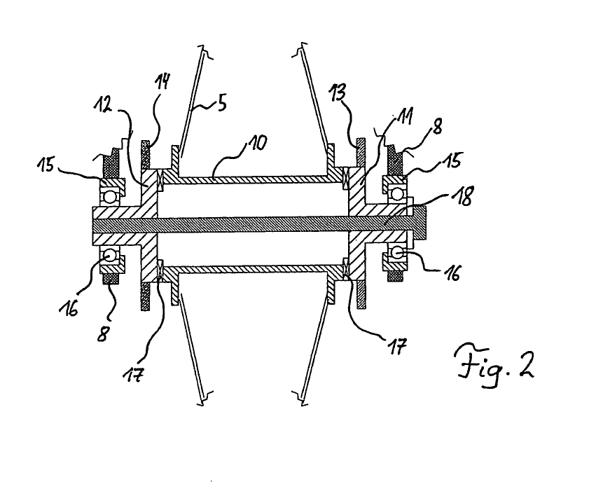

FIG. 2 shows a sectional illustration through FIG. 1 vertically through the rear wheel axle of the bicycle, in a diagrammatic illustration;

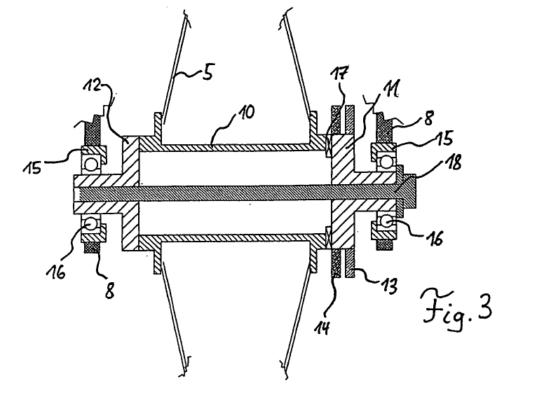

FIG. 3 shows a sectional illustration through FIG. 1 vertically through the rear wheel axle of the bicycle, in a diagrammatic illustration;

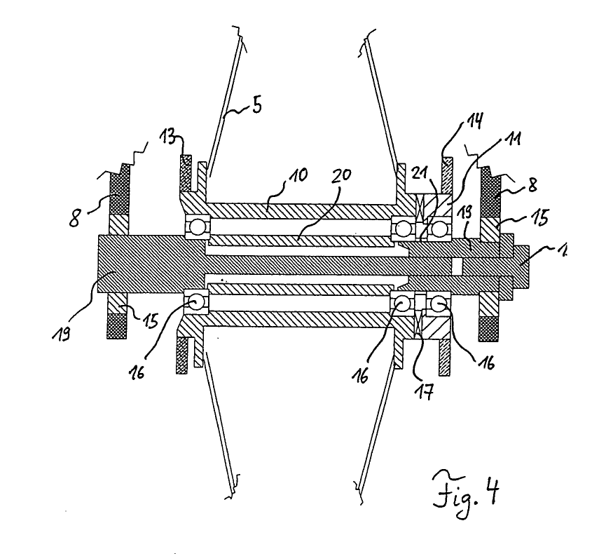

FIG. 4 shows a sectional illustration through FIG. 1 vertically through the rear wheel axle of the bicycle, in a diagrammatic illustration;

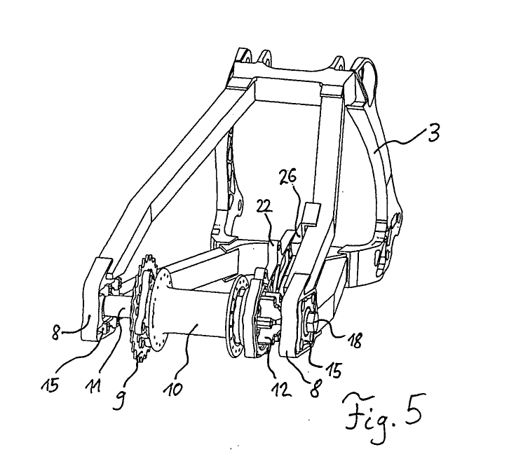

FIG. 5 shows the rear structure of a bicycle with rear wheel hub without spokes and rim, in a perspective view;

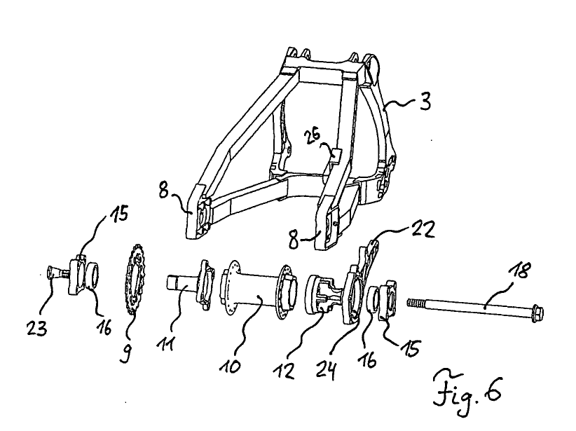

FIG. 6 shows the rear structure of a bicycle with rear wheel hub without spokes and rim, in an exploded illustration;

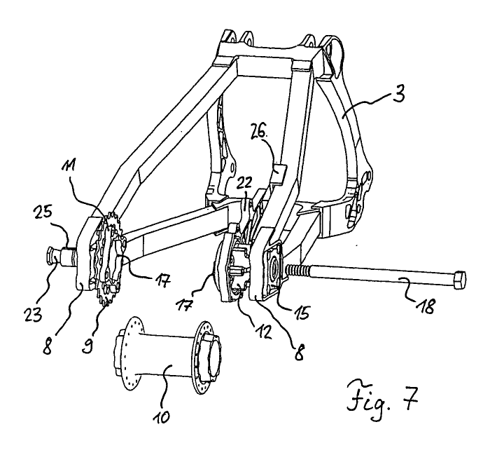

FIG. 7 shows the rear structure of a bicycle with rear wheel hub without spokes and rim and with the hub body removed, in a perspective view from the rear on the right;

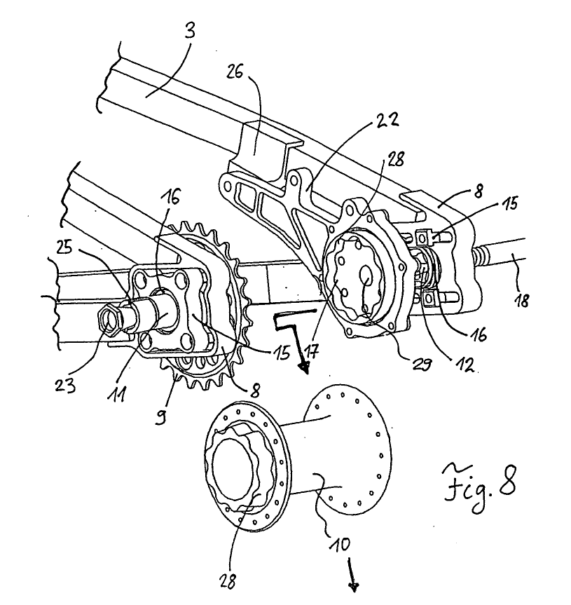

FIG. 8 shows the rear structure of a bicycle with rear wheel hub without spokes and rim and with the hub body removed, in a perspective view from the rear on the left;

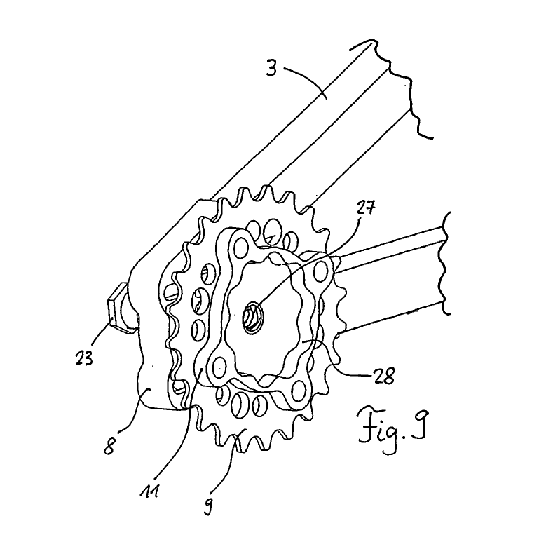

FIG. 9 shows an enlargement of a detail of the left dropout with coupling component and sprocket, taken from FIG. 7.

It should first be noted that screws and threads are not illustrated in FIG. 1 to FIG. 9 to allow better clarity.

FIG. 1 shows the side view of a bicycle, the frame 2 of which with the suspended rear structure 3. The rear wheel 1 is connected to the rear structure 3 at the dropout 8. The rotating pedalling movement of the user drives the chain sprocket 9 of the rear wheel 1 via the chain 4 during the ride. The hub body (not visible here) is connected to the rim 6 via spokes 5. Likewise visible is the brake disk 7 which is connected to the rear wheel hub. A vertical line with the marking A and B marks a section plane which is explained in more detail in FIGS. 2 to 4.

FIG. 2 shows a section through an exemplary embodiment of the rear wheel hub, the rim 6 from FIG. 1 not being illustrated. For this, the spokes 5 are cut free on the rim side and, in this illustration, are only connected to the hub body 10. On both the right and left sides, the hub body 10 has end surfaces with elevations and grooves 17 which can take the moments of the drive elements 13 and brake components 14. The drive elements 13 and brake components 14 themselves are fastened on the two coupling components 11 and 12. In this illustration, the two coupling components 11 and 12 and the hub body 10 are connected to one another in a completely fixed manner via the connecting component 18 and are mounted in the dropout 8 in a manner such that they rotate during the ride. The mounting is achieved via two bearings 16 and two displaceable bearing receptacles 15. It can clearly be seen in FIG. 2 that drive elements 13 and brake components 14 are arranged on different sides. If the brake components 14 and the drive elements 13 are not arranged on the same coupling component, then the drive elements 13 are not able to let negative disturbances pass to the brake components 14. An example which could be mentioned here is the disk brake linings becoming fouled with oil due to chain lubricant being thrown about.

FIG. 3 shows a section through an exemplary embodiment of the rear wheel hub, the rim 6 from FIG. 1 not being illustrated. For this, the spokes 5 are cut free on the rim side and, in this illustration, are only connected to the hub body 10. Only on the right side does the hub body 10 have an end surface with elevations and grooves 17 which can take the torques of the drive elements 13 and brake components 14. The drive elements 13 and brake components 14 themselves are fastened here on one coupling component 11. In this illustration, the coupling component 12 is continuously connected to the hub body 10 and only the coupling component 11 is connected in an entirely fixed manner via the connecting component 18 and is mounted in the dropout 8 in a manner such that it rotates during the ride. The mounting is achieved via two bearings 16 and two displaceable bearing receptacles 15. It can clearly be seen in FIG. 2 that drive elements 13 and brake components 14 are arranged only on the right side. A particularly simple and cost-effectively producible separability between coupling component 11 and the hub body 10 is achieved via this one-sided solution. A solution of this type would also be expedient, for example for the purpose of what are referred to as city bikes.

FIG. 4 shows a section through an exemplary embodiment of the rear wheel hub, the rim 6 from FIG. 1 not being illustrated. For this, the spokes 5 are cut free on the rim side and, in this illustration, are only connected to the hub body 10. Only on the right side does the hub body 10 have an end surface with elevations and grooves 17 which can take the torque of the brake components 14. In this illustration, the drive elements 13 are fastened directly on the hub body 10.

The brake components 14 themselves are fastened here on a coupling component 11. All of the bearings 16 are situated within the hub body 10 and the coupling component 11. The use of a multi-part connecting component 19 achieves a simple construction of the dropouts 8. This is advantageous, for example, if the invention is to be used in already existing bicycle constructions without having to structurally modify the dropout 8. The displaceable bearing receptacle 15 which is only indirectly connected here via the multi-part connecting component 19 to the bearing 16 is likewise shown. Spacer rings 20 and 21 which prevent bearing distortions due to tightening of the multi-part connecting component 19 can also be seen. In this illustration, the arrangement of the drive elements 13 and brake components 14 is selected arbitrarily and a different placing of the drive elements 13 and brake components 14 from the placing illustrated can be undertaken depending on the intended use.

FIG. 5 shows the rear structure 3 of a bicycle with rear wheel hub without front bicycle frame, spokes and rim, in a perspective view; the dropouts 8 are connected fixedly to the rear structure 3 and have a pocket-shaped milled-out portion in which the displaceable bearing receptacle 15 is situated. The hub body 10, which can be seen easily here by way of the numerous holes for receiving the spokes, is situated symmetrically and centrally between the dropouts 8. The coupling component 12 is situated on the right of the hub body 10. On the coupling component 12 there is the brake caliper receptacle 22 which in turn is connected displaceably to the rear structure 3 by means of anti-dive support 26. A ball bearing (not visible within the brake calliper receptacle 22) is situated in relation to the coupling component 12. Threaded holes at which brake disk and brake caliper are fitted are provided on the brake calliper receptacle 22 and the coupling component 12. Disk brake and brake calliper are not illustrated in FIG. 5. The coupling component 11 is on the left of the hub body 10. The chain sprocket 9 is screwed on the coupling component 11. Whether the sprocket is arranged on the left or the right side in bicycles depends on the intended use and is selected arbitrarily in this illustration. In this illustration, the two coupling components 11 and 12 are connected to the hub body 10 via the connecting component 18. The floating mounting of the brake caliper receptacle 22 on the coupling component 12 is advantageous since, in many spheres of use, the reaction moment which is produced at the rear wheel by the braking operation has an effect on the cushioning comfort. Introducing these reaction moments via the brake caliper receptacle into the main frame 2 from FIG. 1 is optimum. However, this is not illustrated in FIG. 5, but can easily be set up.

FIG. 6 shows the rear structure 3 of a bicycle with rear wheel hub without spokes and rim, in an exploded illustration. The dropouts 8 are connected fixedly to the rear structure 3 and have a pocket-shaped milled-out portion in which the displaceable bearing receptacle 15 is situated. The bearings 16 are situated within the bearing receptacles 15. The coupling components 11 and 12 have a mushroom shape and, in the fitted state, are situated with their thin, cylindrical side within the bearings 16. On the left side, the coupling component 11 is slotted and can thereby fixedly accommodate the bearing 16 with the use of a wedge screw 23. The chain sprocket 9 is likewise screwed to the coupling component 11. On the right of the coupling component 12 there is the brake caliper receptacle 22 which, in this illustration, is separated from the anti-dive support 26. A ball bearing 24 (not illustrated in exploded form) is situated within the brake caliper receptacle 22. The connecting component 18, here illustrated as a simple screw which has to be removed in order to remove the hub body, is shown on the right.

FIG. 7 shows the rear structure of a bicycle with rear wheel hub without spokes and rim and with the hub body removed, in a perspective view from the rear on the right in order to explain the removal of the rear wheel in more detail. The right dropout 8 is situated on the right strut of the rear structure 3. The displaceable bearing receptacle 15 with the bearing (not visible) is accommodated within this dropout. The right coupling component 12 is continuously connected to the dropout 8 even when the hub body 10 is taken off. Although the connecting component 18 has been pulled out to the right, the operator cannot unintentionally remove the right coupling component 12, since, even with the hub body 10 having been taken off, it is connected to the rear structure 3 at the anti-dive support 26 via the brake calliper receptacle 22. So that, when the wheel is taken off, the hub body 10 can be lifted axially out of the elevations and grooves of the end sides 17, the left coupling component 11 should be pushed deeply into the left dropout before the wheel is taken off. This is possible even with the chain fitted and tensioned, since the ability to move at an inclination is a conventional characteristic of bicycle chains. The chain is not illustrated in FIG. 7. However, the chain sprocket is illustrated fitted to the left coupling component 11. So that the operator can push the left coupling component 11 to the left deeply into the dropout 8, the wedge screw 23, which is screwed into the left coupling component 11, must be released beforehand. In the left coupling component 11 there is a clamping slot 25 which widens when the wedge screw is tightened and fixes the bearing on the coupling component 11. The connecting component 18 must likewise be removed from the left coupling component 11, so that it can be pushed to the left, into the dropout 8. As soon as the left coupling component 11 has been pushed in, the hub body 10 and therefore also the rear wheel can easily be removed.

FIG. 8 shows the rear structure 3 of a bicycle with rear wheel hub without spokes and rim and with hub body 10 removed, in a perspective view from the rear on the left, in order to further explain the function. The wheel bearing 16 is situated within the displaceable bearing receptacle 15. The anti-dive support 26 also has an elongated hole (not visible here) which permits the relative displacement of brake caliper receptacle 22 to the rear structure 3. After the chain (not illustrated here) which runs over the chain sprocket 9 has been tensioned, the two bearing receptacles 15 can remain permanently once screwed to the dropout 8. All that needs to be done in order to take off the wheel is for the connection component 18 to be completely unscrewed and the wedge screw 23 released. As soon as this has happened, the operator has merely to carry out the movement (illustrated by an arrow) on the hub body 10 and can remove the rear wheel. Releasing the wedge screw 23 causes the clamping slot 25 to relax and causes the connection, which is necessary for the cycling mode, between left coupling component 11 and bearing 16 to be cancelled. Since the right coupling component 12 is only connected to the connecting component 18 via a hole 29, the connecting component 18 are easily removed from the right coupling component 12. While taking off the wheel, the user pulls the polygonal forms of the coupling components 11 and 12 and of the hub body 10 apart in accordance with the arrow movement. The elevations and grooves 17 in polygonal form 28 on the end sides of the coupling component 12 and of the hub body 10 which transmit the torques can readily be seen.

FIG. 9 is an enlargement of a detail of the rear structure 3 with left dropout 8, with coupling component 11 and sprocket 9. The enlargement has been taken from FIG. 7. It can be seen that, for taking off the wheel, the left coupling component 11 has been pushed completely into the dropout 8 when the wedge screw 23 is released. The connecting component (not illustrated here) has been unscrewed from the thread 27 for taking off the wheel.

### List of Designations

1 Rear wheel
2 Bicycle frame
3 Rear structure
4 Chain
5 Spokes
6 Rim
7 Brake disk
8 Dropout
9 Chain sprocket
10 Hub body
11 Coupling component
12 Coupling component
13 Drive element
14 Brake component
15 Bearing receptacle, displaceable
16 Bearing
17 End surface with elevations and grooves
18 Connecting component
19 Multi-part connecting component
20 Spacer ring
21 Spacer ring
22 Brake caliper receptacle
23 Wedge screw
24 Bearing
25 Clamping slot
26 Anti-dive support
27 Thread
28 Polygonal forms
29 Hole

1) A rear wheel and rear wheel hub for bicycles, the rear wheel being mounted between two components of the bicycle frame, and is mounted removably, and the rear wheel hub of a rear wheel being configured indirectly or directly to accommodate brake components and drive elements, comprising:
at least one coupling component is arranged on at least one dropout,
a hub body is arranged on the at least one coupling component such that it can be separated on a coupling side,
a brake component arranged permanently and indirectly or directly on the at least one coupling component,
a drive element is arranged permanently and indirectly or directly on the at least one coupling component,
a releasable connection to a single-or multi-part connecting component at least within the dropout, at least within the one coupling component and within the hub body, and
on the at least one coupling component is a ball, roller or needle bearing in relation to the dropout or in relation to the connecting component.

2) The rear wheel and rear wheel hub for bicycles as claimed in claim 1, wherein the at least one coupling component has a thread into which the connecting component is screwed.

3) The rear wheel and rear wheel hub for bicycles as claimed in claim 1, wherein the connecting component is arranged in an axially displaceable manner within the at least one coupling component.

4) The rear wheel and rear wheel hub for bicycles as claimed in claim 1, wherein the at least one coupling component and the hub body have one or more elevations and grooves on an end side.

5) The rear wheel and rear wheel hub for bicycles as claimed in claim 1, wherein the brake component and drive element are not arranged on a same coupling component.

6) The rear wheel and rear wheel hub for bicycles as claimed in claim 1, wherein, after the connection of the connecting component is released, the hub body is arranged in an axially moveable manner relative to the at least one coupling component.

7) The rear wheel and rear wheel hub for bicycles as claimed in claim 1, wherein, after the connection of the connecting component is released, the at least one coupling component is arranged in an axially moveable manner relative to the dropout.

8) The rear wheel and rear wheel hub for bicycles as claimed in claim 1, wherein, when the connection of the connecting component is closed, the at least one coupling component is arranged in an axially fixable or clampable manner relative to the dropout.

9) The rear wheel and rear wheel hub for bicycles as claimed in claim 1, wherein the ball, roller or needle bearing of the rear wheel is displaceable relative to the bicycle frame on the dropout.

10) The rear wheel and rear wheel hub for bicycles as claimed in claim 4, wherein the elevation and grooves on the at least coupling component and on the hub body have a polygonal form or involute form.

11) The rear wheel and rear wheel hub for bicycles as claimed in claim 10, wherein the polygonal form or involute form of the at least one coupling component and of the hub body are additionally of wedge-shaped design.

12) The rear wheel and rear wheel hub for bicycles as claimed in claim 1, wherein on one coupling component there is a ball, roller or needle bearing for the indirect receptacle of a brake caliper.

13) The rear wheel and rear wheel hub for bicycles as claimed in claim 1, wherein one coupling component remains permanently connected to the dropout.

14) The rear wheel and rear wheel hub for bicycles as claimed in claim 1, wherein the hub body is connected to a rim of the rear wheel via steel spokes or composite fiber materials.

15) The rear wheel and rear wheel hub as claimed in claim 1, wherein the releasable connection between the coupling components and connecting component comprises an eccentric clamp or a disk cam.

16) The rear wheel and rear wheel hub for bicycles as claimed in claim 4, wherein the elevations and grooves on end surfaces of the at least coupling component and on the hub body are composed of a different material from the hub body and the at least one coupling component themselves.

17) The rear wheel and rear wheel hub as claimed in claim 1, wherein separability between the at least one coupling component and the hub body is achieved via a thread.

18) The rear wheel and rear wheel hub as claimed in claim 1, wherein the drive element is configured as a chain sprocket.

19) The rear wheel and rear wheel hub as claimed in claim 1, wherein the drive element is configured as a sprocket for synchronous belts.

20) The rear wheel and rear wheel hub as claimed in claim 1, wherein the brake component is configured as a disk brake.

21) The rear wheel and rear wheel hub as claimed in claim 1, wherein the hub body and the at least coupling component are arranged symmetrically between the dropout.
